(19) United States
(12) Patent Application Publication
(10) Pub. No.: US 2024/0284299 A1
(43) Pub. Date: Aug. 22, 2024

(54) CONDITIONAL COMMUNICATION PATH SWITCH FROM CURRENT INDIRECT PATH TO ALTERNATE INDIRECT PATH

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/569,389

(22) PCT Filed: Jul. 29, 2022
(86) PCT No.: PCT/US2022/038787

§ 371 Date: Dec. 12, 2023

Related U.S. Application Data
(60) Provisional application No. 63/229,801, filed on Aug. 5, 2021.
(60) Provisional application No. 63/308,862, filed on Feb. 10, 2022.

(51) Int. Cl. H04W 40/12; H04W 40/22

(52) U.S. Cl. CPC H04W 40/12; H04W 40/22

(57) ABSTRACT

A serving base station connected to a remote user equipment (UE) device over a current indirect communication path sends a conditional path switch reconfiguration message to the remote UE device. The current indirect communication path is through at least one relay UE device. The conditional path switch reconfiguration message instructs the remote UE device to switch from the current indirect communication path to an alternate indirect communication path when a condition is met. The alternate indirect communication path may be to the serving base station or to an alternate base station.

### CLAIM OF PRIORITY

The present application claims priority to Provisional Application No. 63/229,801, entitled “L2 RELAYING UNDER INTER-GNB HANDOVER,” docket number TPRO 00364 US, filed Aug. 5, 2021, and to Provisional Application No. 63/308,862, entitled “INTER-CELL SERVICE CONTINUITY,” docket number TPRO 00368 US, filed Feb. 10, 2022, which are both assigned to the assignee hereof and hereby expressly incorporated by reference in their entirety.

### FIELD

This invention generally relates to wireless communications and more particularly to management of wireless communication links using relay devices.

### BACKGROUND

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D). In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying and the relay UE device establishes a communication path between the remote UE and a base station (gNB) or cell. In some situations, for example, the UE device may be out of the service area of the base station and the relay UE device provides a communication link routed from such an out-of-coverage (OoC) UE device through a relay UE device to the base station. Where the destination device is another UE device (target UE device), the relaying functionality is typically referred to as UE-to-UE (U2U) relaying.

### SUMMARY

A serving base station connected to a remote user equipment (UE) device over a current indirect communication path sends a conditional path switch reconfiguration message to the remote UE device. The current indirect communication path is through at least one relay UE device. The conditional path switch reconfiguration message instructs the remote UE device to switch from the current indirect communication path to an alternate indirect communication path when a condition is met. The alternate indirect communication path may be to the serving base station or to an alternate base station.

### BRIEF DESCRIPTION OF THE DRAWINGS

FIG. 1A is a block diagram of a communication system for an example where a current relay UE device and candidate relay UE devices transmit reference signals that are received by a remote UE device.

FIG. 1B is a block diagram of the communication system for an example where the base station transmits a path switch conditional reconfiguration to the remote UE device and the selected relay UE device is served by the serving base station.

FIG. 1C is a block diagram of the communication system for an example where the current path is an indirect path to the serving base station and the path switch is to an alternate indirect path through a relay UE device served by another base station.

FIG. 1D is a block diagram of the communication system 100 for the example of FIG. 1C after the conditions for the path switch have been met.

FIG. 2 is a block diagram of an example of a base station.

FIG. 3 is a block diagram of an example of a UE device suitable for use as each of the UE devices.

FIG. 4A is a message diagram for an example of path switching for current indirect to alternate indirect path switching where the target relay UE device is served by the serving base station.

FIG. 4B is a message diagram for an example of path switching for indirect-to-indirect path switching where the target relay UE device is served by a target base station different from the serving base station.

FIG. 5 is a flow chart of an example of a method of managing path switching from indirect-to-indirect communication links.

### DETAILED DESCRIPTION

As discussed above, a relay UE device provides connectivity between a remote UE device and a destination, which can be another UE device (destination UE device) or a network. Where the destination is the network, the relay provides connectivity to a cell provided by a base station (gNB) of the network. The relayed connection between a remote UE device and target UE device is sometimes referred to as a UE to UE (U2U) relay connection. The relayed connection between a remote UE device and a base station (gNB) is sometimes referred to as a UE to network (U2N) relay connection. In some situations, the ultimate destination is a target UE device through the base station. In conventional systems where the relay connects to a base station (gNB), the relay UE device is required to meet certain criteria to function as a relay. For example, the relay UE device must be in coverage and have a cellular (Uu) communication link to the base station of sufficient quality in order to be available for U2N relaying functions.

Sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes a PC5 link (sidelink) between the remote UE device and the relay UE device and the Uu link between the relay UE device and the gNB.

The communication link between a base station and a remote UE device through a Uu link is often referred to as a direct link or a direct path. Where the remote UE device is connected to the base station through a relay UE device, the communication link is often referred to as an indirect link or indirect path. In some situations, the base station (gNB) may determine that a switch from one type of link to another should be performed but only if certain conditions or criteria are met. For example, the base station may determine that a remote UE device connected to the base station via a direct path should switch to an indirect path if the signal quality between the base station and the remote UE device falls below a threshold level and the link quality between the remote UE device and a relay UE device is above a threshold. Unfortunately, at the time the determination is made to switch, it is possible that the current link quality is insufficient for the base station to notify the remote UE device to make the switch. Where the remote UE device is connected to the base station through a current indirect path, for example, the switch to an alternate indirect link may be preferred when the quality of the PC5 link to the current relay UE device is below a threshold. When the quality falls below the threshold, the remote UE device may no longer be able to receive, over the relayed link, an instruction to perform the path switch. For the examples herein, however, the base station sends a path switch conditional reconfiguration message to the remote UE device that instructs the remote UE device to make the path switch when the remote UE device determines that the condition has been met. In the examples discussed below, the path switch conditional reconfiguration message indicates the condition and identifies at least one relay UE device for the new indirect communication path.

Although the techniques discussed herein may be applied to various types of systems and communication specifications, the devices of the example operate in accordance with at least one revision of the 3rd Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D is employed. More specifically the techniques may be applied to current and future releases of 3GPP NR specifications. For example, the techniques may also be applied to 3GPP NR (3GPP Rel-17) and 3GPP Rel-18.

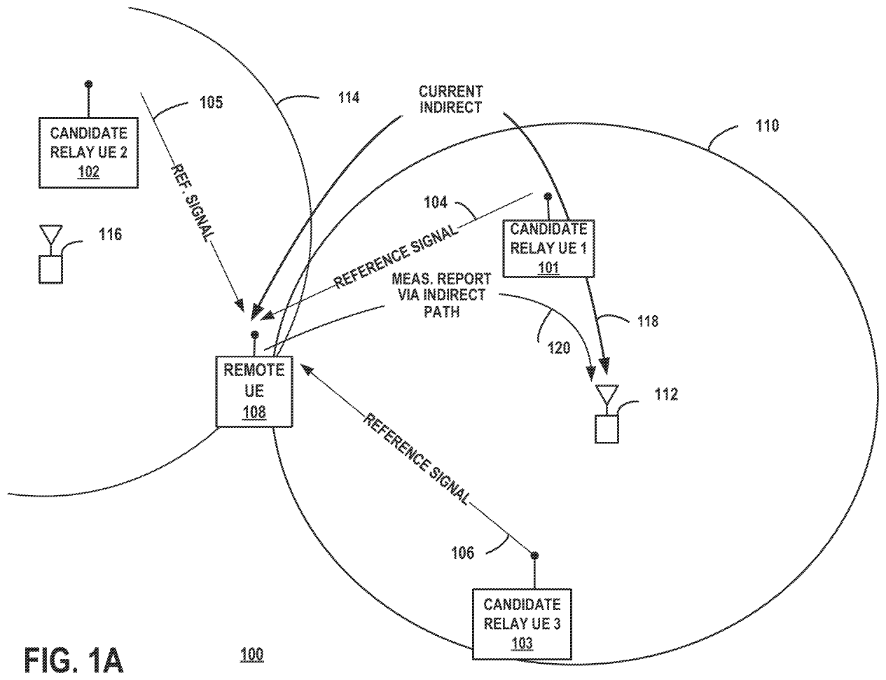

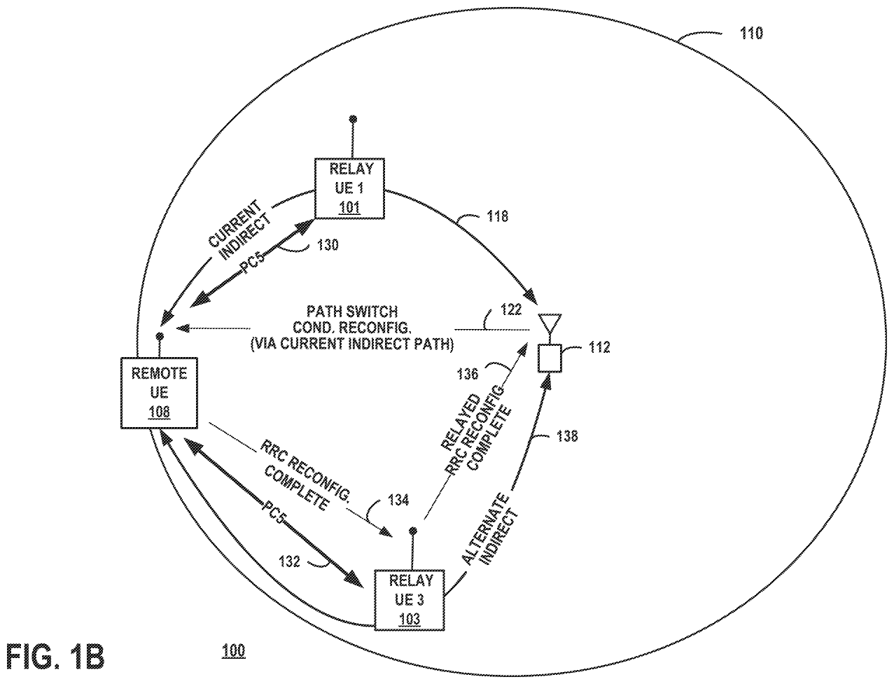

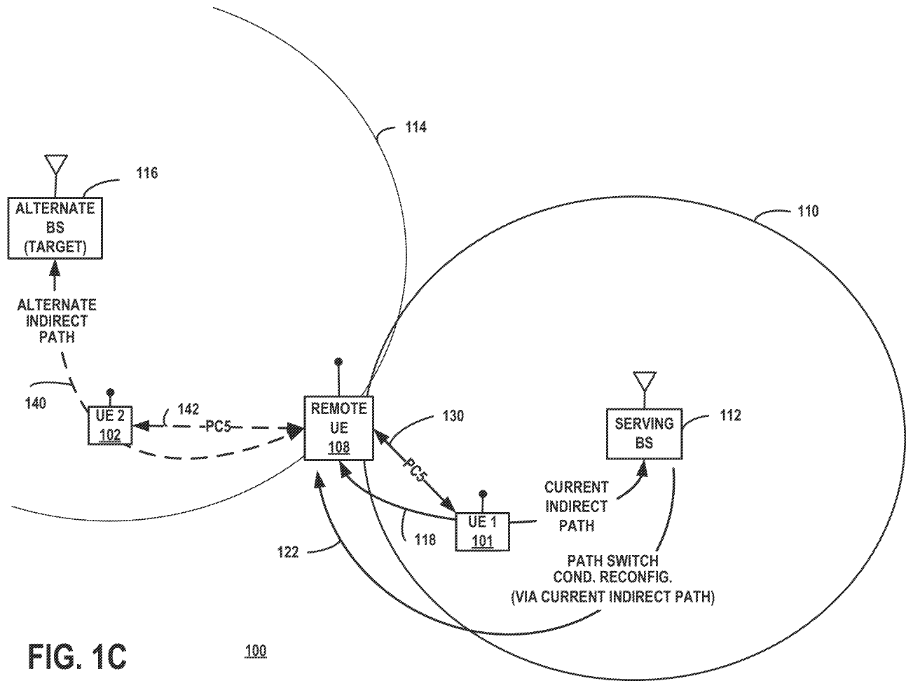

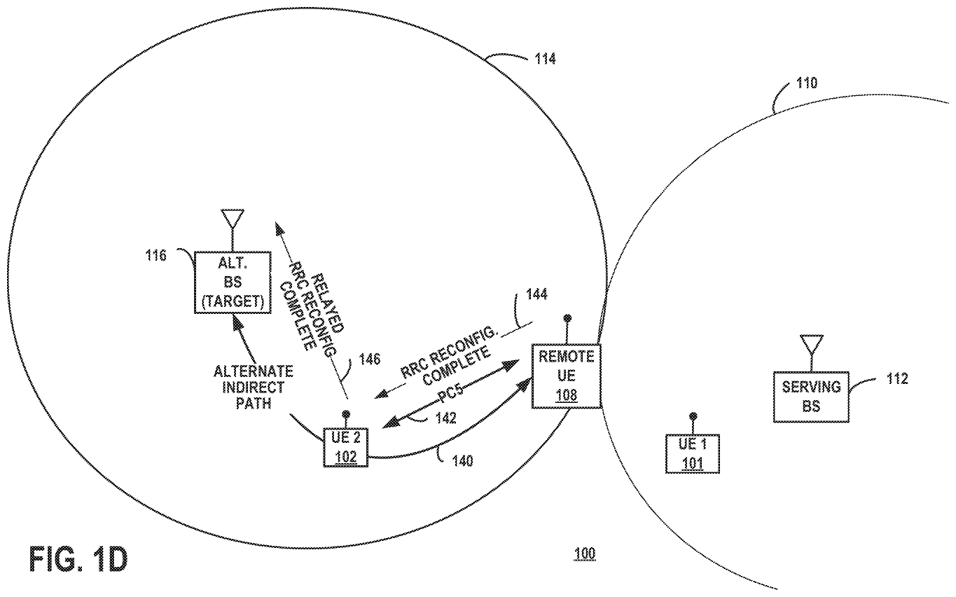

FIG. 1A is a block diagram of a communication system 100 for an example where a current relay UE device 101 and candidate relay UE devices 102, 103 transmit reference signals 104-106 that are received by a remote UE device 108. One candidate relay UE device 103 is within a cell coverage area 110 of a base station (gNB) 112, and a candidate relay UE device 102 is within another cell coverage area 114 of another base station (gNB) 116.

For the example, the remote UE device 108 is in communication with the base station 112 over a current indirect communication path 118 through the current relay UE device 101. The remote UE device 108 receives a reference signal 104 from the current relay UE device 101 and reference signals 105, 106 from each of the relay UE candidate devices 102, 103. For the example, the reference signals 105-106 are sidelink discovery signals where the discovery signal may be a Model A discovery announcement message or a Model B response message. The reference signal 104 from the current relay UE device is any suitable reference signal used for generating a measurement report where an example includes a channel state information reference signal (CSI-RS). The remote UE device 108 generates the measurement report 120 based on measurements of the reference signals 104-106 received at the remote UE device 108. For the example, the measurement report 120 is generated in accordance with at least one revision of the 3GPP communication specification.

FIG. 1B is a block diagram of the communication system 100 for an example where the base station 112 transmits a path switch conditional reconfiguration 122 to the remote UE device 108 and the selected relay UE device is served by the serving base station 112. The scenario of FIG. 1B begins with the remote UE device 108 in communication with the serving base station 112 through an indirect path 118. After receiving the measurement report 120, the base station 112 determines that the remote UE device 108 may need to switch from the current path to an alternate path. The base station 112 determines the conditions or criteria that should be met for the remote UE device 108 to execute a path switch to the alternate path. For the example, the base station 112 includes the conditions in the path switch conditional reconfiguration 122. Although the various conditions may be established, the base station 112 may set signal quality thresholds to define the condition. For the examples herein, the condition includes a minimum current path signal quality threshold for the current path and a minimum alternate path signal quality threshold for an alternate communication path. An example of a suitable threshold parameter includes reference signal received power (RSRP). Other examples include Reference Signal Received Quality (RSRQ), Signal to Interference plus Noise Ratio (SINR) and Signal to Noise plus Interference Ratio (SNIR). The path switch conditional reconfiguration 122 is similar to conventional reconfiguration messages except the reconfiguration message includes the criteria under which one or more of the conditional handover (CHO) candidate relay UE devices (indirect path switch) or CHO candidate cells (direct path switch) need to be satisfied based on the configured threshold for RSRP (Sidelink Discovery-RSRP (SD-RSRP) or Sidelink RSRP (SL-RSRP) for PC5 link), RSRQ and/or SINR. This differs from the conventional handover procedure whereby one or more measurement events need to be satisfied.

The path switch conditional reconfiguration 122 may identify multiple alternate paths by identifying candidate relay UE devices and/or base stations. For the example, at least the alternate indirect path 124 through the relay UE device 103 is identified. After receiving the path switch conditional reconfiguration 122 over the current indirect path 118, the remote UE device 108 monitors the conditional parameters of the current path and the alternate path(s). For the example, the remote UE device 108 measures the SL-RSRP of the PC5 link 130 to the relay UE device 101, and measures the SD-RSRP of the PC5 link 132 to the relay UE device 103. When the RSRP of the PC5 link 130 falls below the minimum current path RSRP threshold and the SD-RSRP of one of the PC5 links to one of the identified relay UE devices is above minimum alternate path RSRP threshold, the remote UE device 108 initiates a path switch to the relay UE device with the PC5 link having the SD-RSRP above the threshold. In some cases, the CHO evaluation only requires that the PC5 link of one of the relay UE devices exceeds the configured SD-RSRP threshold. In the cases when there are more than one relay UE device that satisfies the CHO criteria, it is up to the remote UE device 108 which relay UE device to connect to for the path switch.

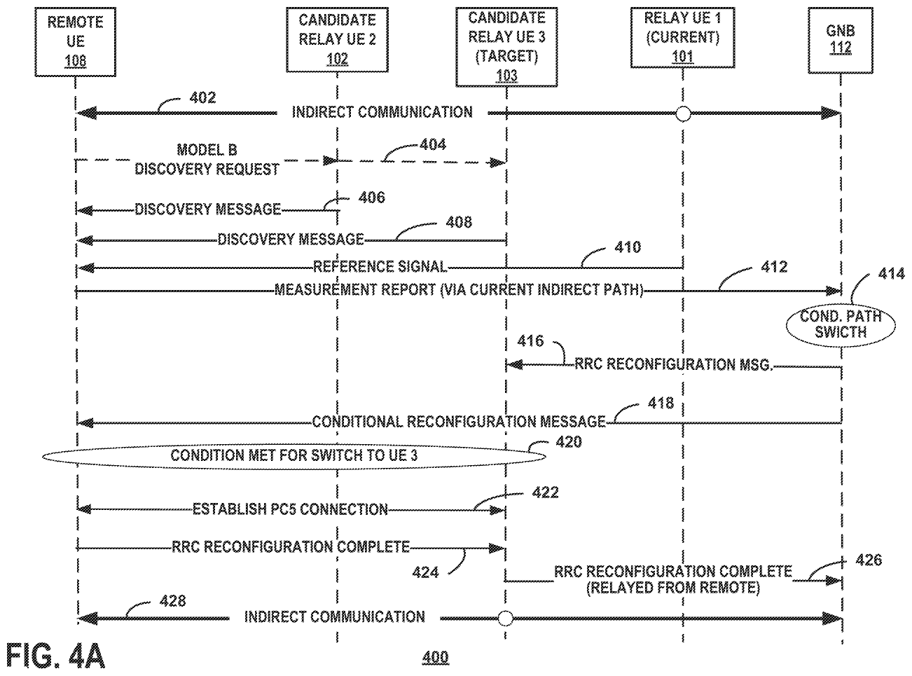

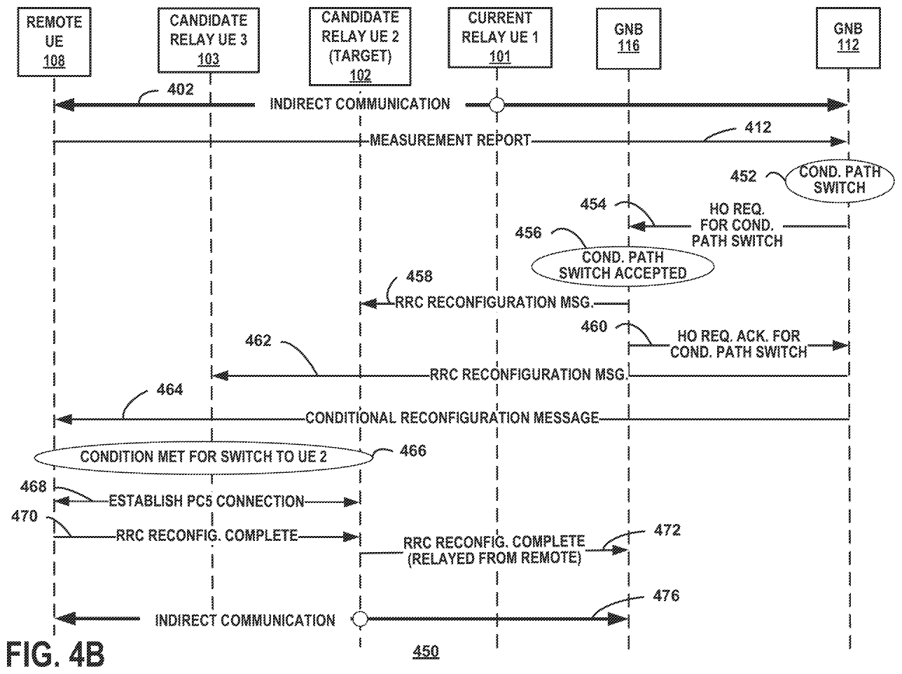

Prior to sending the path switch conditional reconfiguration 122, the serving base station 112 prepares the target relay UE device 103 for the conditional path switch. As discussed below with reference to FIG. 4A, the serving base station 112 transmits a Radio Resource Control (RRC) reconfiguration message to each candidate relay UE device. For the example of FIG. 1B, therefore, the relay UE device 103 is configured to provide relay service to the remote UE device 108. Although the relay UE device 103 is in the RRC Connected (RRC CONN) state in the example, in some situations the relay UE device 103 may be in RRC IDLE or RRC INACTIVE. In such situations, a technique is used to transition the relay UE device 101 to RRC CONN to complete the path switch. Examples of such techniques are discussed in PCT Patent Application Number PCT/US2022/037067, entitled “PATH SWITCH TO INDIRECT COMMUNICATION THROUGH RELAY UE DEVICE IN RRC CONNECTION STATE OTHER THAN RRC CONNECTED”, Attorney Docket Number TUTL 00363C PC, filed on Jul. 14, 2022, and hereby expressly incorporated by reference in its entirety.

For the example of FIG. 1B, the relay UE device 103 is determined to have a link quality above the threshold. After determining the condition of the path switch has been met, the remote UE device 108 established the PC5 link 132, if not already established, and transmits a Radio Resource Control (RRC) Reconfiguration Complete message 134 destined to the serving base station 112. The relay UE device 101 relays the RRC Reconfiguration Complete message to the serving base station 112 by transmitting a relayed RRC reconfiguration message 136 to establish the alternate indirect path 138.

FIG. 1C is a block diagram of the communication system 100 for an example where the current path is an indirect path 118 to the serving base station 112 and the path switch is to an alternate indirect path 140 through a relay UE device 102 served by another base station 116. The example begins with the remote UE device 108 connected to the serving base station 112 over the current indirect path 118. The serving base station 112 has received a measurement report 120 from the remote UE device 108 and determined that the remote UE device 108 should be configured with a conditional path switch. The serving base station 112 transmits a path switch conditional reconfiguration 122 to the remote UE device 108 over the current indirect path 118 through the current relay UE devoice 101.

Prior to sending the path switch conditional reconfiguration, the serving base station 112 prepares the target base station 116 for the conditional path switch. As discussed below with reference to FIG. 4B, the serving base station 112 exchanges messages with one or more candidate target base stations. Each of the candidate target base stations are serving one or more candidate relay UE devices that may be used to provide an alternate indirect path for the remote UE device 108. As part of the conditional path switch preparation, the target base station 116 configures the candidate target relay UE device(s). For the example of FIG. 1C, therefore, the relay UE device 102 is configured to provide relay service to the remote UE device 108.

The path switch conditional reconfiguration 122 is transmitted by the base station 112 and received by the remote UE device 108. The remote UE device 108 monitors the communication links related to the conditions of the conditional path switch and determines that the conditions have been met for switching to an indirect path 126 through the relay UE device 102. The path switch conditional reconfiguration 122 identifies at least one relay UE device for an alternate indirect path 140. In some situations, multiple candidate relay UE devices may be identified. Therefore, the relay UE device 102 may be one relay UE device of a set of candidate relay UE devices (not shown in FIG. 1C) identified by the path switch conditional reconfiguration 122. In response to determining that the conditions for the conditional path switch have been met, the remote UE device 108 establishes the PC5 link 142 with the relay UE device 102, if not already established.

FIG. 1D is a block diagram of the communication system 100 for the example of FIG. 1C after the conditions for the path switch have been met. After the PC5 link 140 to the relay UE device 102 is established, the remote UE device 108 transmits a Radio Resource Control (RRC) Reconfiguration Complete message 144 destined to the target base station 116. The relay UE device 102 relays the RRC reconfiguration complete message to the target base station 116 by transmitting a relayed RRC reconfiguration message 146. Communication continues between the alternate base station 116 over the alternate indirect path 140.

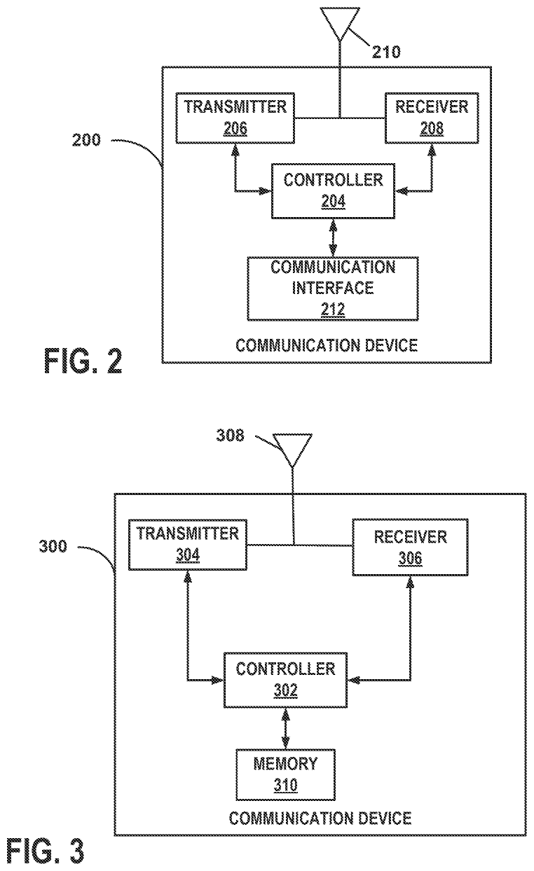

FIG. 2 is a block diagram of an example of a base station 200 suitable for use as the base station 112, base station 116, and any base station providing a cell or otherwise serving any of the UE devices. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base stations 112, 116, 200 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 101-103, 108. In some examples, the UE device 300 is any wireless communication device such as a mobile phone, a transceiver modem, a personal digital assistant (PDA), a tablet, or a smartphone. In other examples, the UE device 300 is a machine type communication (MTC) device or Internet-of-Things (IoT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 306 and transmitter 304 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 306, therefore, may include components such as low noise amplifiers (LNAs) and filters. The transmitter 304 may include filters and amplifiers. Other components may include isolators, matching circuits, and other RF components. These components in combination or cooperation with other components perform the communication device functions. The required components may depend on the particular functionality required by the communication device.

The transmitter 304 includes a modulator (not shown), and the receiver 306 includes a demodulator (not shown). The modulator can apply any one of a plurality of modulation orders to modulate the signals to be transmitted as part of the uplink signals. The demodulator demodulates the downlink signals in accordance with one of a plurality of modulation orders. The communication device 300 includes memory 310 in addition to memory that is part of the controller 302. Information related to the conditional path switch may be stored and maintained on the memory 310, the controller 302, or a combination of the two.

FIG. 4A is a message diagram 400 for an example of path switching for current indirect to alternate indirect path switching where the target relay UE device is served by the serving base station 112. Although FIG. 4A shows three candidate relay UE devices 102-103, any number of candidate relay devices may be involved in the messaging. The example begins with the remote UE device 108 in indirect communication 402 with the base station (gNB) 112. Uplink data and downlink data are exchanged between the remote UE device 108 and the gNB 112 over the indirect path 402 through the current relay UE device 101.

At transmission 404, a Model B discovery request is sent to the nearby candidate relay UE devices. In some situations, the Model B discovery request may be omitted. Accordingly, the arrow representing the Model B discovery request is illustrated with a dashed line to indicate that the transmission may not be needed. For example, where Model A discovery messages are received from the candidate relay UE devices, the Model B request may not be needed.

At transmission 406, a discovery message is sent from the candidate relay UE device 102. At transmission 408, a discovery message is sent from the candidate relay UE device 103. At transmission 410, a reference signal is sent from the current relay UE device 101. The discovery messages of the transmissions 406, 408 may be Model A discovery announcement messages or may be Model B discovery response messages. The reference signal transmitted from the current relay UE device 101 may be a channel state information reference signal (CSI-RS). The remote UE device 108 receives the discovery messages and evaluates the received signals and information as part of the relay reselection procedure. For the examples, the remote UE device 108 measures the SD-RSRP levels of the received discovery messages and measures the SL-RSRP of the CSI-RS.

At transmission 412, the remote UE device 108 sends a measurement report to the gNB 112 where the measurement report includes signal quality measurements for candidate relay devices 102, 103 and the current relay UE device 101. Accordingly, the measurement report includes the signal quality measurements, such as the SD-RSRP levels, of the discovery signals 406, 408, and the SL-RSRP of the reference signal transmission 410.

At event 414, the gNB 112 determines that a conditional path switch should be established for the remote UE device 108 to facilitate a path switch from the current indirect connection to an alternate indirect connection when conditions are met. The decision by the gNB 112 to establish a conditional path switch to the alternate indirect communication may be based on any combination of factors, such as which event triggered the measurement reporting, the SD-RSRP level(s), the SL-RSRP of the reference signal 410, the RRC connection status, and the congestion level of the candidate relay UE (the gNB may know how many remote UE devices are already connected to a particular candidate relay UE). For the example of FIG. 4A, the gNB 112 selects the relay UE device (UE3) 103 as the candidate UE device. The candidate relay UE device 103 is served by the serving base station 112 and is in RRC CONN for the example. Additional messaging may be required where a candidate relay UE device is not in RRC CONN. In some situations, the selected candidate relay UE devices include relay UE devices served by other bases stations, such as the relay UE device 102. The number of selected candidate relay UE devices may range from one device to numerous devices.

At transmission 416, the gNB 112 sends an RRC Reconfiguration message to the target relay UE device 103 to configure both the sidelink Radio Link Control (RLC) configuration and the RLC configuration in the Uu link, as well as establishing the remote UE identifier (ID) to be used for the relay operation. Therefore, the candidate relay UE device is prepared for providing relay service for the remote UE device 108 if and when the remote UE device 108 determines that conditions have been met to switch to an indirect path through the candidate relay UE device 103.

At transmission 418, the gNB 112 transmits a conditional reconfiguration message to the remote UE device 108. The conditional reconfiguration message is a path switch reconfiguration that instructs the remote UE device 108 to perform a path switch to an indirect path through a candidate relay device when conditions are met.

At event 420, the remote UE device 108 determines the conditions have been met to switch to an indirect path. For the example, the remote determines that a measured RSRP of the current path is below a minimum current path RSRP threshold and that a measured SD-RSRP of the PC5 link to the target relay UE device 103 is above a minimum alternate path RSRP threshold. In some situations, other signal quality threshold can be used where examples include Reference Signal Received Quality (RSRQ), Signal to Interference plus Noise Ratio (SINR) and Signal to Noise plus Interference Ratio (SNIR). As part of the determination that the conditions have been met to switch to an indirect path, the remote UE device 108 also verifies that the target relay UE device 103 is still camped on the cell of the serving base station (gNB) 112.

At event 422, a PC5 connection is established between the remote UE device 108 and the target candidate relay UE device 103. In some situations, the PC5 connection may already be established, and event 422 is not needed.

At transmission 424, the remote UE device 108 sends an RRC Reconfiguration Complete message intended for the gNB 112 via the candidate relay UE device 103. The RRC Reconfiguration Complete message 424 is received at the target relay UE device 103 over the PC5 link.

In response to receiving the RRC Reconfiguration Complete message in transmission 424, the target relay UE device 103 relays the RRC Reconfiguration Complete message received from the remote UE device 108 to the gNB 112 at transmission 426. Communication between the remote UE device 108 and the gNB 112 continues over the indirect communication link 428, which includes a relay connection through the relay UE device 103.

As discussed above, the target relay UE device may perform an RRC resume procedure or an RRC establishment procedure when the relay UE device is not in RRC CONN. The RRC resume procedure and RRC establishment procedure can be triggered by receipt of the RRC Reconfiguration Complete message at the target Relay UE device.

FIG. 4B is a message diagram 450 for an example of path switching for indirect-to-indirect path switching where the target relay UE device is served by a target base station 116 different from the serving base station 112. Although FIG. 4B shows two candidate relay UE devices 102, 103, any number of candidate relay devices may be involved in the messaging. The example begins with the remote UE device 108 in indirect communication 402 with the base station (gNB) 112 through the current relay UE device 101. Discovery procedures and reference signal measurements are performed in accordance with the example of FIG. 4A, and transmissions 404, 406, 408, 410 are omitted in FIG. 4B in the interest of clarity and brevity.

At transmission 412, the remote UE device 108 sends a measurement report to the gNB 112 where the measurement report includes signal quality measurements for candidate relay devices and the current PC5 link to the relay UE device 101. Accordingly, the measurement report includes the signal quality measurements, such as the SD-RSRP levels, of the discovery signals 406, 408, and the SL-RSRP level of the reference signal 410.

At event 452, the gNB 112 determines that a conditional path switch should be established for the remote UE device 108 to facilitate a path switch from the current indirect connection to an alternate indirect connection when conditions are met. The decision by the gNB 112 to establish a conditional path switch to indirect communication may be based on any combination of factors, such as which event triggered the measurement reporting, the SD-RSRP level(s), the SL-RSRP level of the current PC5 link, the RRC connection status, and the congestion level of the candidate relay UE devices (the gNB may know how many remote UE devices are already connected to a particular candidate relay UE). For the example of FIG. 4B, the gNB 112 selects the relay UE device (UE2) 102 and the relay UE device (UE 3) 103 as the candidate UE devices. The candidate relay UE device 103 is served by the serving base station 112, and the candidate relay UE device 102 is served by a target gNB 116. Both candidate relay UE devices are in RRC CONN for the example. As discussed below, other transmissions may be necessary where the target UE device is in an RRC connection state other than RRC CONN. The number of selected candidate relay UE devices may range from one device to numerous devices, and, in some situations, the selected candidate relay UE devices include relay UE devices served by other alternate base stations in addition to the serving gNB 112 and the target gNB 116.

The gNB 112 prepares other gNBs and candidate relay UE devices served by those other gNBs for the conditional path switch. For the example, therefore, the target UE device 102 and the target gNB 116 are prepared for the conditional path switch. Although other techniques may be used, the gNB 112 applies a modified version of conventional conditional handover (CHO) messaging to setup the conditional path switch. The serving base station (gNB) 112 is a source base station in terms of a handover. At transmission 454, the serving gNB 112 transmits a handover request message for conditional path switch to the target gNB 116, which includes the context of the remote UE device 108 and identifies candidate relay UE devices served by the target gNB 116. For the example, therefore, the handover request message for conditional path switch is a conditional handover request message that conveys the context of the remote UE device 108 and identifies the target relay UE device 102. The handover request message for conditional path switch is transmitted over an Xn connection between the base stations 112, 116. In some situations, the PC5 measurements result for the target UE device 102 may be included in the request message. This may be advantageous where the requirements for a remote UE to a relay UE could differ from cell to cell.

At event 456, the target gNB 116 determines that the conditional path switch can be accommodated. The target gNB 116 evaluates conditions in the target cell to determine whether the target gNB 116 has the ability to accept the path switch. For example, the gNB 116 may determine that due to load balancing, the path switch cannot be accommodated.

At transmission 458, the target gNB 116 transmits an RRC reconfiguration message to the candidate relay UE devices to prepare the relay UE devices for the path switch. For the example of FIG. 4B, therefore, the target gNB 116 transmits an RRC reconfiguration message to the target relay UE device 102. In some situations, the candidate relay UE device may not be in RRC CONN, and the target gNB 116 is unable to transmit the RRC reconfiguration message. In such situations, the target gNB 116 sends the RRC reconfiguration message after receiving a relayed RRC Reconfiguration Complete message from the target relay UE device 102. As discussed in the PCT Patent Application entitled “PATH SWITCH TO INDIRECT COMMUNICATION THROUGH RELAY UE DEVICE IN RRC CONNECTION STATE OTHER THAN RRC CONNECTED” referenced above, the Reconfiguration Complete message transmitted by the remote UE device 108 and received at the target relay UE device 102 triggers the target relay UE device 102 to perform a RRC reestablishment procedure or RRC Resume procedure. The receipt of the relayed Reconfiguration Complete message at the target gNB 116 then triggers the target gNB 116 to transmit the RRC reconfiguration message.

At transmission 460, the target gNB 116 sends a Handover Request Acknowledgement (ACK) for conditional path switch to the serving gNB 112. The message is similar to a conventional Handover Request Acknowledgement except that the ACK includes information related to the target relay UE devices. The Handover Request Acknowledgement identifies one or more target relay UE devices that are acceptable to the target base station 116 for the path switch. For example, the target base station 116 may choose a subset of the candidate relay UE devices that are served by the target base station 116. Such a selection could be based on the SD-RSRP level, Uu RSRP level and/or the RRC state of the candidate relay UE.

The target base station 116 also informs the remote UE 108 via the source base station 112 of the proper SL-RSRP or SD-RSRP threshold to use for satisfying the CHO requirement. In some cases, the two threshold levels may be the same.

At transmission 462, the gNB 112 sends an RRC Reconfiguration message to the candidate relay UE device 103 to configure both the sidelink RLC configuration and the RLC configuration in the Uu link, as well as establishing the remote UE ID to be used for the relay operation. Therefore, the candidate relay UE devices 103 is prepared for providing relay service for the remote UE device 108 if and when the remote UE device 108 determines that conditions have been met to switch to an indirect path through the candidate relay UE device 103.

At transmission 464, the gNB 112 transmits a conditional reconfiguration message to the remote UE device 108. The conditional path switch reconfiguration message instructs the remote UE device 108 to perform a path switch to an indirect path through a candidate relay device when conditions are met. As discussed above, the conditional path switch reconfiguration message provides the conditions required for the switch and identifies the candidate relay UE devices 102, 103.

At event 466, the remote UE device 108 determines the conditions have been met to switch to an indirect path. For the example, the remote UE device 108 determines that a measured RSRP of the current path is below a minimum current path RSRP threshold and that a measured SD-RSRP of the PC5 link to the target relay UE device 102 is above a minimum alternate path RSRP threshold. In some situations, other signal quality thresholds can be used where examples include Reference Signal Received Quality (RSRQ), Signal to Interference plus Noise Ratio (SINR) and Signal to Noise plus Interference Ratio (SNIR). As part of the determination that the conditions have been met to switch to an indirect path, the remote UE device 108 also verifies that the target relay UE device 102 is camped on a cell that is provided by one of the target gNBs. For the example, the remote UE device 108 may perform the path switch to the target relay UE device even if the target relay UE device 102 has reselected a different cell from the cell of the original target gNB 116. For the example, however, the path switch is allowed only if the reselected cell of the target relay UE device 102 is provided by a gNB that is a target gNB providing a cell where at least one candidate relay UE device was camped on when the conditional path switch was established. In other words, the gNB is one of the target gNBs prepared for the conditional path switch by the serving gNB 112. Otherwise, the remote UE device 108 will not consider the target relay UE device as a CHO candidate even if the configured threshold is satisfied. If none of the other CHO candidates are available, the remote UE device 108 may inform its serving base station 112 of the changed condition (i.e., the target relay UE device is no longer served by the target base station 116). If the serving base station 112 is no longer reachable, the remote UE device 108 declares a handover failure and performs a connection re-establishment procedure.

At event 468, a PC5 connection is established between the remote UE device 108 and the target candidate relay UE device 102. In some situations, the PC5 connection may already be established, and event 468 is not needed.

At transmission 470, the remote UE device 108 sends an RRC Reconfiguration Complete message intended for the target gNB 116 via the candidate relay UE device 102. The RRC Reconfiguration Complete message is received at the target relay UE device 102 over the PC5 link.

In response to receiving the RRC Reconfiguration Complete message in transmission 470, the target relay UE device 102 relays the RRC Reconfiguration Complete message received from the remote UE device 108 to the gNB 116 at transmission 472. Communication between the remote UE device 108 and the gNB 116 continues over the indirect communication link 474, which includes a relay connection through the relay UE device 102.

As discussed above, the target relay UE device may perform an RRC resume procedure or an RRC establishment procedure when the relay UE device is not in RRC CONN. The RRC resume procedure and RRC establishment procedure can be triggered by receipt of the RRC Reconfiguration Complete message at the target Relay UE device.

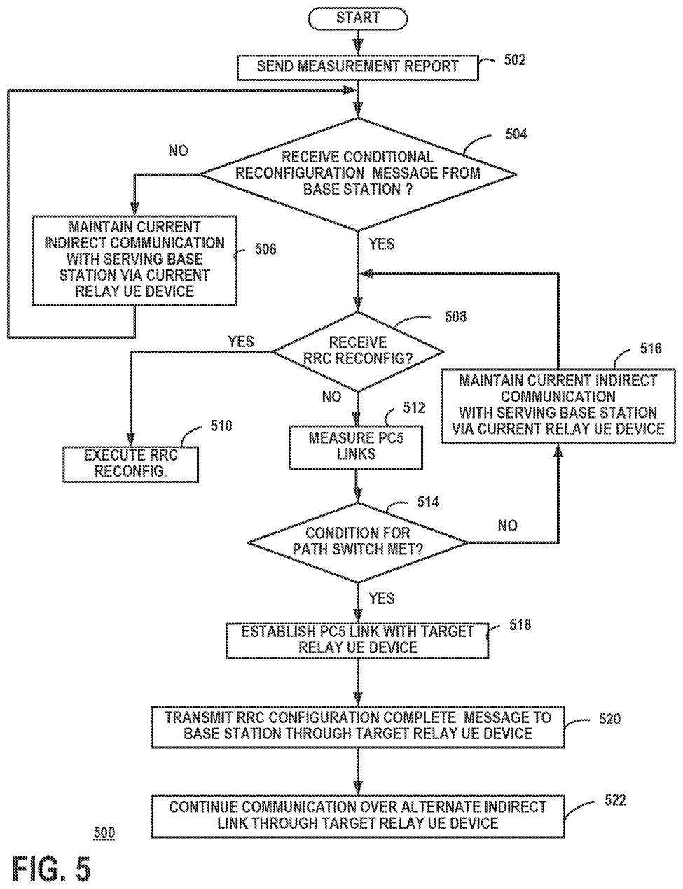

FIG. 5 is a flow chart of an example of a method of managing path switching from indirect-to-indirect communication links. The method is performed by UE device that is connected to a base station through a current indirect path. For the example, therefore, the method may be performed by the remote UE device 108 connected to the serving base station 112.

At step 502, a measurement report is transmitted to the serving base station 112. The remote UE device 108 measures reference signals, such a discovery messages and the CSI-RS, transmitted from UE devices and generates the measurement report.

A step 504, it is determined whether a path switch conditional reconfiguration message has been received from the serving base station 112. If no path switch conditional reconfiguration message has been received (step 506), the method returns to step 504 to continue monitoring incoming reconfiguration messages. In some situations, the method may return to step 502 to transmit another measurement report. If a path switch conditional reconfiguration message has been received, the method proceeds to step 508.

At step 508, it is determined whether an RRC reconfiguration message has been received. Where the serving base station 112 determines that the conditional path switch should be revoked or otherwise terminated, the base station 112 transmits an RRC reconfiguration message to the remote UE device 108. If an RRC reconfiguration message is received, the method proceeds to step 510 where the RRC reconfiguration is executed. In other words, the base station 112 can override the pending conditional path switch by sending the RRC reconfiguration message. If no RRC reconfiguration message is received, the method proceeds to step 512.

At step 512, the signal quality levels of the current PC5 link to current relay UE device 101 and the PC5 links to the candidate relay UE devices are measured. For the example, the RSRP levels of the links are measured. As discussed above, other signal quality parameters and ratios may be measured in some situations.

At step 514, it is determined whether the conditions for the path switch have been met. The remote UE device 108 evaluates the RSRP level the current PC5 link current relay UE device 101 to determine if the measured RSRP of the PC5 link is below the current path RSRP threshold and evaluates the SD-RSRP levels of the PC5 links of the candidate relay UE devices to determine if any of the SD-RSRP levels are above the alternate path RSRP threshold. If a PC5 link is not yet established, the remote UE device 108 establishes the PC5 link based on the measured SD-RSRP. If the current PC5 link RSRP is below the current path RSRP threshold and one of the PC5 link SD-RSRP levels to a candidate relay UE device is above the alternate path RSRP threshold, the remote UE device 108 further determines whether the candidate relay device is camped on a cell that allows a path switch. Where the candidate relay UE device was originally served by the serving gNB 112, it is determined whether the candidate relay UE device is still in the cell. Where the candidate relay UE device was originally served by a target gNB 116, it is determined whether the candidate relay UE device has reselected a different cell and, if so, whether the different cell is provided by another target gNB that was serving at least one of the candidate relay UE devices identified in the path switch conditional reconfiguration. Therefore, if the target cell is one of the “prepared” base stations (i.e., another candidate relay UE device in the CHO list was served by the same target cell), then the remote UE device may select the relay UE device. Otherwise, the target relay UE device is not considered as a CHO target.

There are several situations that may occur where relay UE devices may move to different cells and which are evaluated to determine whether a path switch should be performed. Where the target relay UE device is in the serving cell at time of the transmission of the conditional reconfiguration and the target relay UE device remains in the serving cell, the path switch can be performed. Where the target relay UE device is in the serving cell at time of the transmission of the conditional reconfiguration but the target relay UE device reselects a cell of a target gNB that was one of the gNBs that was prepared for the conditional path switch for another candidate relay UE, the path switch can be performed. Where the target relay device is in the serving cell at time of the transmission of the conditional reconfiguration but the target relay UE device reselects a cell of another gNB that was not one of the target gNBs that was prepared for the conditional path switch for another candidate relay UE device, the path switch should not be performed. Where the target relay UE device is in a target cell of a target gNB at the time of the transmission of the conditional reconfiguration and the target relay UE device remains in a target cell of the target gNB, the path switch should be performed. Where the target relay UE device is in a cell of a target gNB at the time of the transmission of the conditional reconfiguration and the target relay UE device reselects a cell of another target gNB that was one of the gNBs that was prepared for the conditional path switch for another candidate relay UE device, the path switch should be performed. Where the target relay UE device is in a cell of target gNB at the time of transmission of the conditional reconfiguration but the target relay reselects a cell of a gNB that was not one of the target gNBs that was prepared for the conditional path switch for another candidate relay UE device, the path switch should not be performed. Where the target relay UE device is in a cell of a target gNB at the time of the transmission of the conditional reconfiguration and the target relay UE device reselects a cell of the serving gNB, the path switch should be performed.

If all of the conditions are not met for a path switch, the remote UE device 108 maintains the current indirect communication path with the serving base station 112 at step 516 and returns to step 508. If it is determined that all conditions are met for a path switch through the target relay UE device, the method continues at step 518.

At step 518, a PC5 link with the target relay UE device is established. In some circumstances the PC5 link may already be active, and step 518 can be omitted.

At step 520, an RRC Configuration Complete message is transmitted to the base station 112 through the target relay UE device. Where the target relay UE device is camped on a cell of the serving gNB 112, the RRC Configuration Complete message is directed to the serving gNB 112. Where the target relay UE device is camped on a cell of a target gNB 116, the RRC Configuration Complete message is directed to the target gNB 116.

After the relayed RRC Reconfiguration Complete message is received at the appropriate base station, communication between the remote UE device 108 and the appropriate base station continues over the indirect path through the relay UE device.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A remote user equipment (UE) device comprising:
a controller configured to maintain a connection with a serving base station over a current indirect communication path, the current indirect communication path through a current relay UE device;
a receiver configured to receive, from the serving base station over the current indirect communication path, a conditional reconfiguration message instructing the remote UE device to switch from the current indirect communication path to an alternate indirect communication path when a condition is met, the alternate communication path through a target relay UE device not in the current indirect communication path.

2. The remote UE device of claim 1, wherein the condition comprises an alternate quality level of radio link to the target relay UE device exceeding an alternate quality link threshold.

3. The remote UE device of claim 2, wherein the condition further comprises a current quality level of a current indirect link to the current relay UE device being below a current quality link threshold.

4. The remote UE device of claim 3, wherein:
the alternate quality level of the radio link to the target relay UE device is a measured alternate radio signal received power (RSRP),
the alternate quality link threshold is an alternate link RSRP threshold,
the current quality level of the current indirect link to the current relay UE device is a measured current link RSRP, and
the current quality link threshold is a current link RSRP threshold.

5. The remote UE device of claim 4, wherein the measured alternate RSRP is one of a sidelink discovery RSRP (SD-RSRP) and a sidelink RSRP (SL-RSRP).

6. The remote UE device of claim 3, wherein:
the alternate quality level, the alternate quality link threshold, the current quality level, and the current quality link threshold are Reference Signal Received Quality (RSRQ) values.

7. The remote UE device of claim 3, wherein:
the alternate quality level, the alternate quality link threshold, the current quality level, and the current quality link threshold are Signal to Interference plus Noise Ratio (SINR) values.

8. The remote UE device of claim 3, further comprising a transmitter configured to transmit an RRC Reconfiguration Complete message to the target relay UE device in response to the controller determining the alternate quality level of radio link to the target relay UE device exceeds the alternate quality link threshold.

9. The remote UE device of claim 3, further comprising a transmitter configured to transmit an RRC Reconfiguration Complete message to the relay UE device in response to the controller determining the current quality level of the current indirect link to the current relay UE device is below a current quality link threshold and determining the alternate quality level of the radio link to the target relay UE device exceeds the alternate quality link threshold.

10. The remote UE device of claim 1, wherein the receiver, the serving base station and the at least one relay UE device are configured to operate in accordance with at least one revision of the 3rd Generation Partnership Project (3GPP) New Radio (NR) V2X communication specification.

11. The remote UE device of claim 1, wherein the target relay UE device is served by the serving base station.

12. The remote UE device of claim 1, wherein the target relay UE device is served by a target base station different from the serving base station.
